(19) United States
(12) Patent Application Publication
(10) Pub. No.: US 2004/0025721 A1
(43) Pub. Date: Feb. 12, 2004

(54) Flexible squeegee

(76) Inventor: Jeffrey S. Pingel, Hudson, FL (US)

Correspondence Address: Arthur W. Fisher, III, Suite 316, 5553 West Waters Avenue, Tampa, FL, 33634, US

(21) Appl. No.: 10/213,743

(22) Filed: Aug. 6, 2002

(51) Int. Cl. B41F 15/44

(52) U.S. Cl. 101/123

(57) ABSTRACT

A screen printing squeegee to manually apply ink or pigment through a screen or mesh membrane onto a substrate comprising a squeegee holder including a blade channel to operatively receive a squeegee blade therein having a squeegee handle thereon such that the centerline axis of the squeegee handle is inclined relative to the centerline axis of the squeegee blade wherein the acute angle formed by the intersection of the centerline axis of the squeegee handle and the centerline axis of the squeegee blade is about 60 degrees whereby the squeegee is manually pushed across the substrate away from the operator when the centerline axis of the squeegee handle forms an angle of from about 150 degrees to about 130 degrees with the substrate.

### BACKGROUND OF THE INVENTION

1. Field of the Invention

A screen printing squeegee to manually apply ink or pigment through a screen or mesh membrane onto a substrate.

2. Description of the Prior Art

In screen printing, there are many variables which effect the printing quality including the squeegee's durometer, leading edge sharpness and angle of inclination.

In smaller businesses, screen printing remains largely a manual process. Unfortunately, users performing frequent repetitions of motions that put stress on the hand or arm may suffer from carpal tunnel syndrome. This is caused by injury to tendons of the wrist.

Hand tools used for repetitive task such as in screen printing may cause such strain on the hand that carpal tunnel syndrome occurs in the tool user.

Squeegees used for applying fluid in screen printing are designed to be gripped in a manner to place strain on the wrist tendons resulting in carpal tunnel injuries. Numerous efforts have been made to minimize the risk of carpal tunnel injuries.

U.S. Pat. No. 3,110,919 relates to a spreader having an angular upper edge that is not contoured to the shape of the hand.

U.S. Pat. No. 3,676,888 describes an adjustable squeegee for applying synthetic sealing material to damaged surfaces of automobile bodies or the like which may be made in one piece having a stiffening rod through the upper portion. Alternatively, the upper portion may be formed separately with the blade attached. The upper edge does not conform to the shape of the hand.

U.S. Pat. No. 4,254,527 discloses a window cleaning implement having a short handle attached directly to one side of the plate. The handle is designed so that it only requires holding with the fingers and not with the entire palm of the hand.

U.S. Pat. No. 4,297,761 describes a multi-purpose garbage disposal utensil for scraping material into a garbage disposer. The top surface is horizontally flattened, not shaped to fit the palm of a hand.

U.S. Pat. No. 4,027,353 discloses a cleaning apparatus for cleaning window panes with a replaceable strip-shaped rubber wiping element and a detachable clamping plate formed at its transverse front edge with an inwardly angled tapering lip which engages between one side of the holding sheath and the wiping element.

U.S. Pat. No. 4,989,511 shows a handle for a tool the operation of which requires frequent repetitive motions of a hand or arm of a user includes a substantially flat upper surface disposed at an angle of about 70-90 degrees to a longitudinal axis of the handle, and is characterized by an asymmetrical cross-sectional profile with respect to said longitudinal axis. The upper surface of the handle is disposed between convex portions on each side of the surface over which the plams and fingers of the user are curved. The handle is useful for tools for stressful tasks such as for a handle of a squeegee for spreading fluid on a surface of a silkscreen during printing. When the device is used as intended with the wrists substantially straight, the squeegee blade is held at an appropriate angle for silkscreen printing. Carpal tunnel injuries are generally avoided.

U.S. Pat. No. 4,989,512 relates to a squeegee device for use in a silk-screen printer and which comprising a squeegee with a plurality of support positions each being intended to support a squeegee profile of predetermined height dimension, and a squeegee holder.

U.S. Pat. No. 5,410,957 discloses a screen printing apparatus including a squeegee held at an angle to the work piece by a squeegee holder.

U.S. Pat. No. 5,458,060 and U.S. Pat. No. 5,694,842 describe an improved squeegee holder for screen printing to position a squeegee at an angle to the work piece.

Des. 357,563 shows an ornamental design for a squeegee with an inclined squeegee element.

Additional examples of the prior art are shown in U.S. Pat. Nos. 4,075,730; 4,430,769; 4,473,944; 4,941,228 and 5,694,842.

### SUMMARY OF THE INVENTION

The present invention relates to a screen printing squeegee to manually apply ink or pigment through a screen or mesh membrane onto a work piece or substrate.

The screen printing squeegee comprises a squeegee holder to hold or receive a squeegee blade and a squeegee handle to grasp, position and manipulate or operate the screen printing squeegee relative to the work piece or substrate.

The squeegee handle comprises a reduced inner handle portion and an enlarged outer handle portion such that the palm and area between the thumb and index finger of each hand grasp opposite sides of the reduced inner handle portion.

The screen printing squeegee is used to apply an ink or pigment through a screen or mesh membrane having a pattern formed thereon onto a substrate to create an image thereon.

In use, the screen printing squeegee is tilted at an angle of from about 10 degrees to about 20 degrees. Downward pressure is applied on the screen or mesh membrane as the screen printing squeegee is pushed across the screen or mesh membrane. The screen printing squeegee wipes the ink or pigment across the screen or mesh membrane depositing the ink or pigment through the mesh openings in the screen or mesh membrane onto the substrate being printed.

The angle formed at the intersection of horizontal surface of the screen or mesh membrane and the longitudinal center line of the elongated substantially rectangular blade member is from about 10 degrees to about 20 degrees, generally about 15 degrees without pressure applied on the screen printing squeegee. The angle formed at the intersection of longitudinal center line of the elongated substantially rectangular blade member and the longitudinal center line of the squeegee handle is from about 45 degrees to about 75 degrees; preferably about 60 degrees. Thus, the angle formed between the longitudinal center line of the screen or mesh membrane and the substrate is from about 165 degrees to about 115 degrees; preferably from about 130 degrees to 140 degrees.

The downward pressure exerted on the screen printing squeegee deforms the squeegee blade to produce an actual printing angle slightly greater at the leading or contact edge due to the bending or deformation of the squeegee blade.

The invention accordingly comprises the features of construction, combination of elements, and arrangement of parts that will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is an exploded perspective view of the screen printing squeegee of the present invention.

FIG. 2 is a side view of the screen printing squeegee of the present invention.

FIG. 3 is a schematic side view of the screen printing squeegee of the present invention depicting the relative angular inclination of the centerline axes of the squeegee handle, squeegee blade and substrate.

FIG. 4 is a side view of the screen printing squeegee of the present invention and a screen printing device.

FIG. 5 is a detailed exploded view of a fastener used with the screen printing squeegee of the present invention.

Similar reference characters refer to similar parts throughout the several views of the drawings.

### DETAILED DESCRIPTION OF THE PREFERRED EMBODIMENT

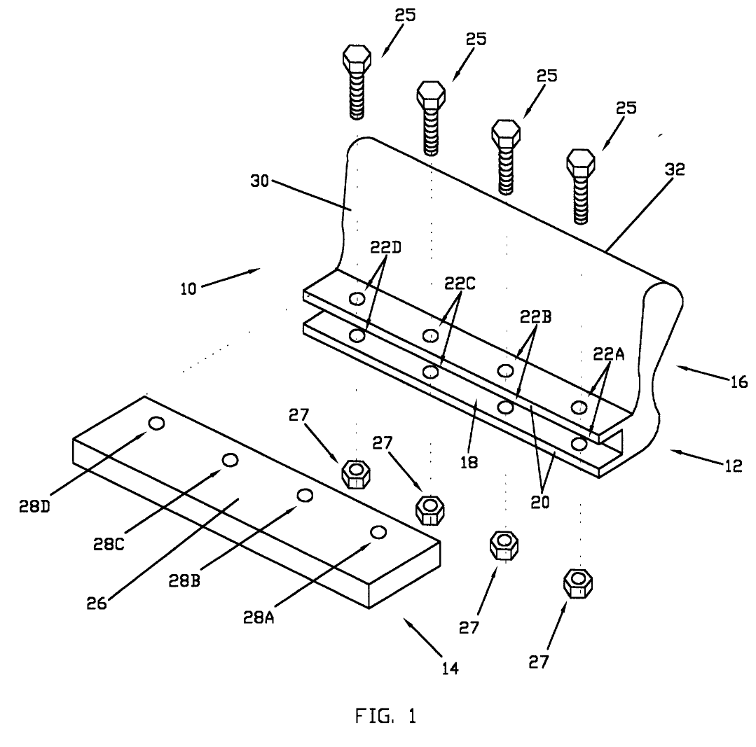

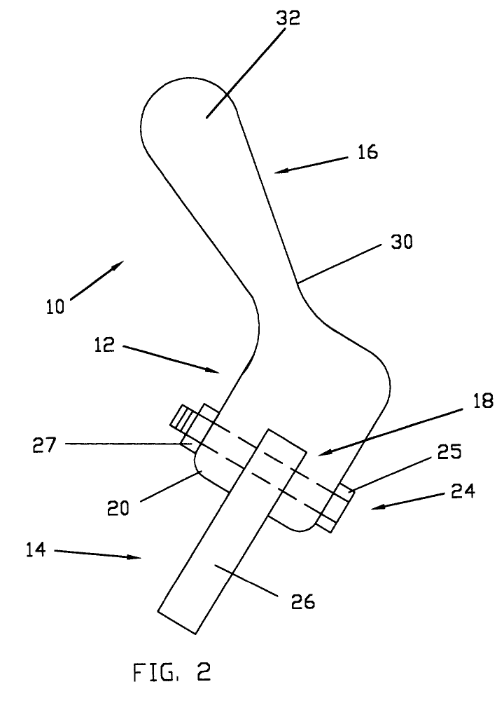

As best shown in FIGS. 1 and 2, the present invention relates to a screen printing squeegee generally indicated as 10 to manually apply ink or pigment through a screen or mesh membrane onto a work piece or substrate as described more fully hereinafter.

As shown in FIGS. 1 and 2, the screen printing squeegee 10 comprises a squeegee holder generally indicated as 12 to hold or receive a squeegee blade generally indicated as 14 and a squeegee handle generally indicated as 16 to grasp, position and manipulate or operate the screen printing squeegee 10 relative to the work piece or substrate.

The squeegee holder 12 comprises an elongated substantially rectangular blade channel or slot 18 cooperatively formed between a pair of substantially parallel squeegee holder members each indicated as 20 extending substantially the width of the printing screen squeegee 10 to receive a portion of the squeegee blade 14 therein when the screen printing squeegee 10 is assembled. A plurality of corresponding pairs of aligned fastener apertures each indicated as 22 are formed through the squeegee holder member 20 to selectively receive corresponding fasteners each generally indicated as 24 to selectively secure the squeegee blade 14 in the elongated substantially rectangular blade channel or slot 18. The fasteners 24 may comprise a bolt and nut combination indicated as 25 and 27 respectively. Of course, the fasteners may comprise a rivet member or the like press fitted through the corresponding pairs of aligned fastener apertures 22A, 22B, 22C and 22D.

The squeegee blade 14 comprises an elongated substantially rectangular blade member 26 having a plurality of blade apertures each indicated as 28 disposed to align with a corresponding pairs of aligned fastener apertures 22 to receive a corresponding fastener 24 therethrough.

The squeegee handle 16 comprises a reduced inner handle portion 30 and an enlarged outer handle portion 32 such that the palm and area between the thumb and index finger of each hand is cradled by the enlarged outer handle portion 32, while the fingers and thumb of each hand grasp opposite sides of the reduced inner handle portion 30. The thickness of the squeegee handle 16 can differ depending on the type of material used to construct the squeegee handle 16.

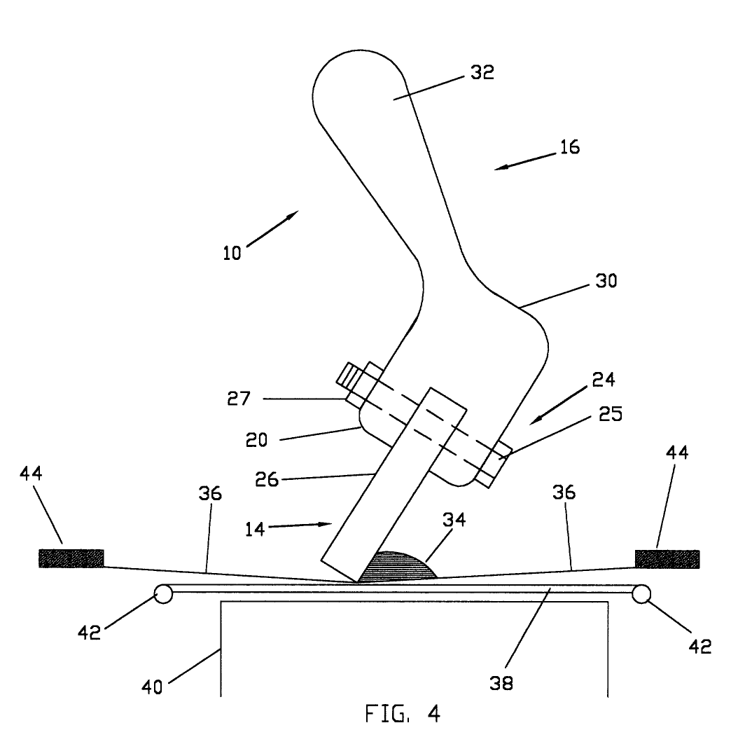

As shown in FIG. 4, the screen printing squeegee 10 is intended for use to apply an ink or pigment 34 through a screen or mesh membrane 36 having a pattern formed thereon onto a substrate 38 to create an image thereon. The substrate 38 is typically supported on a table 40 or other support structure such as rollers or frame 42. As shown, the screen or mesh membrane 36 may be anchored or in a frame 44.

Screen or mesh membrane 36 is a fabric screen with openings in the mesh through which the ink or pigment 34 is deposited on the substrate 38. The quantity of ink or pigment 34 deposited is controlled by the mesh opening, thickness of the fabric, thickness of the emulsion, off distance between the screen or mesh membrane 36 and the substrate 38, squeegee blade durometer, squeegee blade sharpness and squeegee angle.

As shown in FIG. 4, the screen printing squeegee 10 is tilted at an angle of from about 10 degrees to about 20 degrees as described hereinafter. Downward pressure is applied on the screen or mesh membrane 36 as the screen printing squeegee 10 is pushed across the screen or mesh membrane 36 in the direction of travel shown by the arrow. The screen printing squeegee 10 wipes the ink or pigment 34 across the screen or mesh membrane 36 that is anchored at opposite ends 44. The ink or pigment 34 is then deposited through the mesh openings in the screen or mesh membrane 36 onto the substrate 30 being printed.

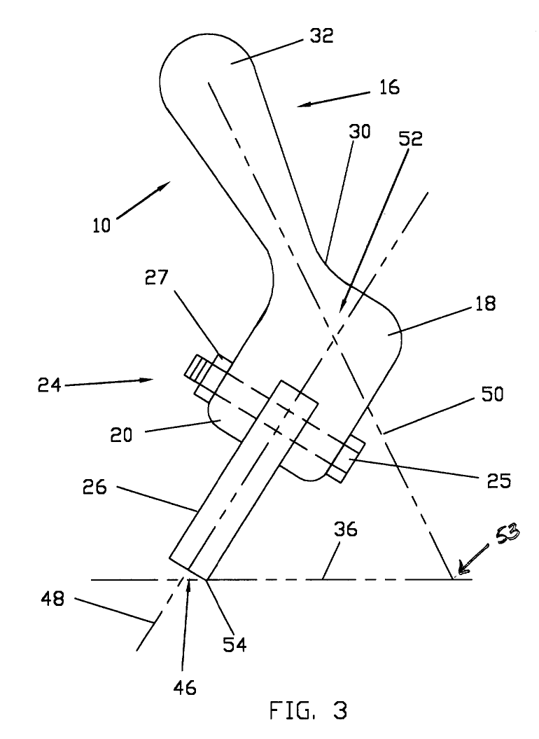

As shown in FIG. 3, the angle 46 formed at the intersection of horizontal surface of the screen or mesh membrane 36 and the longitudinal center line 48 of the elongated substantially rectangular blade member 26 is from about 10 degrees to about 20 degrees, generally about 15 degrees without pressure applied on the screen printing squeegee 10. The angle 52 formed at the intersection of longitudinal center line of the elongated substantially rectangular blade member 48 and the longitudinal center line 50 of the squeegee handle 16 is from about 45 degrees to about 75 degrees; preferably about 60 degrees. Thus, in use the angle 53 formed at the intersection of the longitudinal center line 15 of the squeegee handle 16 and the screen or mesh membrane 36 is from about 165 degrees to about 115 degrees; preferably from about 130 degrees to about 140 degrees, and most preferably about 135 degrees.

The downward pressure exerted on the screen printing squeegee 10 deforms the squeegee blade 14 to produce an actual printing angle at the leading or contact edge 54 greater than the angle at the intersection due to the bending or deformation of the squeegee blade 26.

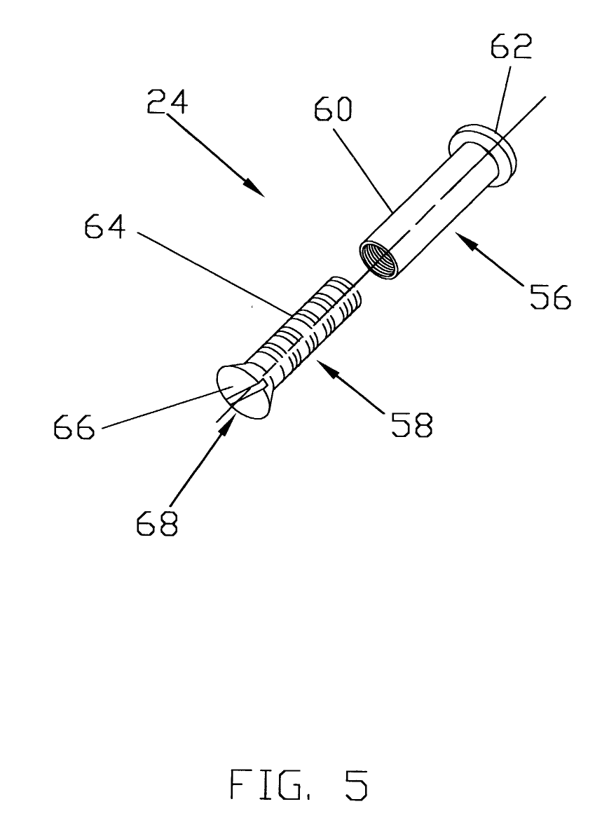

As shown in FIG. 5, each fastener 24 may comprise a first element 56 and a second element 58 configured to pass through the corresponding pairs of aligned fastener apertures 22A, 22B, 22C and 22D and the corresponding blade aperture 28 to secure the elongated substantially rectangular blade member 26 in the elongated substantially rectangular blade channel or slot 18. The first element 56 may comprise an elongated internally threaded member 60 having an enlarged end portion or stop 62 formed thereon and the second element 58 may comprise an externally threaded member 64 to operatively engage the elongated internally threaded member 62 and an enlarged end portion or stop 66 including a groove 68 to tighten second element 58 and elongated internally threaded member 60 together when assembled onto the screen printing squeegee 10.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A screen printing squeegee to manually apply ink or pigment through a screen or mesh membrane onto a substrate comprising a squeegee holder to operatively retain a squeegee blade having a squeegee handle such that the centerline axis of said squeegee handle is inclined relative to the centerline axis of the squeegee blade whereby the squeegee is manually pushed across the substrate away from the operator.

2. The screen printing squeegee of claim 1 wherein the angle formed at the intersection of horizontal surface of the screen or mesh membrane and the longitudinal center line of said squeegee blade is from about 10 degrees to about 20 degrees, and the angle formed at the intersection of longitudinal center line of said squeegee blade member and the longitudinal center line of said squeegee handle is from about 45 degrees to about 75 degrees and the angle formed between the longitudinal center line of said squeegee handle and the screen or mesh membrane is from about 165 degrees to about 115 degrees.

3. The screen printing squeegee of claim 1 wherein the centerline axis of said squeegee handle forms an angle of from about 150 degrees to about 130 degrees with the substrate.

4. The screen printing squeegee of claim 1 wherein the centerline axis of said squeegee handle forms an angle of from about 135 degrees with the substrate.

5. The screen printing squeegee of claim 1 wherein the acute angle formed by the intersection of the centerline axis of the squeegee handle and the centerline axis of the squeegee blade is about 60 degrees.

6. The screen printing squeegee of claim 1 wherein the angle formed between the longitudinal center line of said squeegee handle and the screen or mesh membrane and the substrate is from about 165 degrees to about 115 degrees.

7. The screen printing squeegee of claim 5 wherein said squeegee holder comprises an elongated blade slot to receive a portion of said squeegee blade therein when said screen printing squeegee is assembled.

8. The screen printing squeegee of claim 7 further comprising a plurality of corresponding pairs of aligned fasteners apertures formed through said squeegee holder member and a corresponding plurality of aperture is formed through said squeegee blade to selectively receive corresponding fasteners to selectively secure said squeegee blade in said elongated blade slot.

9. The screen printing squeegee of claim 8 wherein said elongated blade slot is cooperatively formed between a pair of substantially parallel squeegee holder members.

10. The screen printing squeegee of claim 8 wherein said elongated blade slot extends substantially the width of said printing screen squeegee.

11. The screen printing squeegee of claim 1 wherein said squeegee holder comprises an elongated blade slot to receive a portion of said squeegee blade therein when said screen printing squeegee is assembled.

12. The screen printing squeegee of claim 11 wherein the angle formed between the longitudinal center line of said squeegee handle and the screen or mesh membrane and the substrate is from about 165 degrees to about 115 degrees.

13. The screen printing squeegee of claim 12 further comprising a plurality of corresponding pairs of aligned fasteners apertures formed through said squeegee holder member and a corresponding plurality of aperture is formed through said squeegee blade to selectively receive corresponding fasteners to selectively secure said squeegee blade in said elongated blade slot.

14. The screen printing squeegee of claim 11 wherein the angle formed at the intersection of horizontal surface of the screen or mesh membrane and the longitudinal center line of said squeegee blade is from about 10 degrees to about 20 degrees, and the angle formed at the intersection of longitudinal center line of said squeegee blade member and the longitudinal center line of said squeegee handle is from about 45 degrees to about 75 degrees and the angle formed between the longitudinal center line of said squeegee handle and the screen or mesh membrane is from about 165 degrees to about 115 degrees.

15. The screen printing squeegee of claim 14 further comprising a plurality of corresponding pairs of aligned fasteners apertures formed through said squeegee holder member and a corresponding plurality of aperture is formed through said squeegee blade to selectively receive corresponding fasteners to selectively secure said squeegee blade in said elongated blade slot.

16. The screen printing squeegee of claim 11 wherein the centerline axis of the squeegee handle forms an angle of from about 150 degrees to about 130 degrees with the substrate.

17. The screen printing squeegee of claim 11 wherein the centerline axis of said squeegee handle forms an angle of from about 135 degrees with the substrate.

18. The screen printing squeegee of claim 16 further comprising a plurality of corresponding pairs of aligned fasteners apertures formed through said squeegee holder member and a corresponding plurality of aperture is formed through said squeegee blade to selectively receive corresponding fasteners to selectively secure said squeegee blade in said elongated blade slot.

19. The screen printing squeegee of claim 11 wherein the acute angle formed by the intersection of the centerline axis of the squeegee handle and the centerline axis of the squeegee blade is about 60 degrees.

20. The screen printing squeegee of claim 19 further comprising a plurality of corresponding pairs of aligned fasteners apertures formed through said squeegee holder member and a corresponding plurality of aperture is formed through said squeegee blade to selectively receive corresponding fasteners to selectively secure said squeegee blade in said elongated blade slot.

21. The screen printing squeegee of claim 1 wherein said squeegee handle comprises a reduced inner handle portion and an enlarged outer handle portion such that the palm and area between the thumb and index finger of each hand is cradled by said enlarged outer handle portion while the fingers and thumb of each hand grasp opposite sides of said reduced inner handle portion.

22. The screen printing squeegee of claim 21 wherein the angle formed at the intersection of horizontal surface of the screen or mesh membrane and the longitudinal center line of said squeegee blade is from about 10 degrees to about 20 degrees, and the angle formed at the intersection of longitudinal center line of said squeegee blade member and the longitudinal center line of said squeegee handle is from about 45 degrees to about 75 degrees and the angle formed between the longitudinal center line of said squeegee handle and the screen or mesh membrane is from about 165 degrees to about 115 degrees.

23. The screen printing squeegee of claim 21 wherein the angle formed between the longitudinal center line of said squeegee handle and the screen or mesh membrane and the substrate is from about 165 degrees to about 115 degrees.

24. The screen printing squeegee of claim 21 wherein the centerline axis of said squeegee handle forms an angle of from about 135 degrees with the substrate.
